(19) United States
(12) Patent Application Publication
(10) Pub. No.: US 2013/0028262 A1
(43) Pub. Date: Jan. 31, 2013

(54) METHOD AND ARRANGEMENT FOR MESSAGE ANALYSIS

(71) Applicants: Lauri Piikivi, Oulu (FI); Rauli Kaksonen, Oulu (FI)

(72) Inventors: Lauri Piikivi, Oulu (FI); Rauli Kaksonen, Oulu (FI)

(21) Appl. No.: 13/640,813

(22) PCT Filed: Apr. 26, 2011
(86) PCT No.: PCT/FI2011/050377

§ 371 Date: Oct. 12, 2012

(30) Foreign Application Priority Data
Apr. 26, 2010 (FI) 20105450

(51) Int. Cl. H04L 12/56

(52) U.S. Cl. 370/392

(57) ABSTRACT

The method is for preparing data read from data communication network for testing purposes. The method has steps for reading data from a communication network, adding at least one header data field to the received data to create a packet interpretable by a network protocol dissector, and forwarding the created data packet to the network protocol dissector for further conversion of read data to a data analysis format. An arrangement and a computer program product are also disclosed.

### PRIOR APPLICATIONS

This is a US national phase patent application that claims priority from PCT/FI2011/050377 filed 26 Apr. 2011, that claims priority from Finnish Patent Application No. 20105450, filed 26 Apr. 2010.

### TECHNICAL FIELD OF INVENTION

The invention relates to a method and arrangement for analyzing a network message, e.g. for the purpose of testing a network protocol.

### BACKGROUND OF THE INVENTION

It is time consuming to create a model of the protocol for a robustness tester. The specification of the protocol is often proprietary.

The effort required for testing a proprietary protocol may be significantly reduced by utilizing a network protocol dissector. There are dissectors available for a large number of protocols e.g. through Wireshark open-source network capture application. The dissectors require for input network capture data (e.g. data in

PCAP format), that contains the header information of all layers of the network protocol stack. In other words, in order to be usable for a widely known network protocol dissector, the network traffic must be captured at lowest protocol level (e.g. Ethernet) of the network interface.

The dissectors are able to produce user-readable data, e.g. PDML (Packet Details Markup Language) output of the PCAP. PDML data contains the content of the captured data packets with useful meta-data information about the fields of the packet. Hence the data content of the packet is easier for a human to read in the PDML format. The PDML format is highly usable format for e.g. testing purposes.

There may be also other formats beside PDML, which may be used in a similar fashion.

When reading data at the level of lowest protocol of a network interface, all data of the network interface is captured. Filters may be applied to limit the captured data, but may be difficult to define appropriate filter for a task in hand. Capturing may produce potentially a large amount of data that is irrelevant for the tested higher level protocol. Furthermore, reading data at the level of lowest protocol of a network interface of a Device Under Test (DUT) often requires administrative rights to the operating system of the device. Alternatively or additionally, some special software may need to be installed to the device to capture the network data. When testing a device, such administrative rights may not be available and/or there is no possibility to install additional special-purpose software to the device for testing purposes.

Captures can be used as samples for outgoing messages, but incoming messages at test time may pose a problem, as they are not understood by the robustness testing SW without dissecting the message first. Protocols often have sequence numbers, identifiers and checksums etc, that are needed to be correct for the message exchange of the protocol to proceed. For example, when a message is sent, the received message may contain a “session id” value that needs to be placed for the 2^{nd} message to be sent so that the messages are correctly processed by right recipient process in correct state. In PCAP format these kind of dynamic rules are not present. They must be created by the user.

User can select the values from the received protocol content and assign them to dynamic rules and the dynamic rule output to a message that will be sent next. Rule will calculate the correct values when the capture is replayed e.g. as a test. Rule can for example copy an ID from received message and replace the old, incorrect capture sample based value in the next outgoing message. This ensures that the protocol sequence proceeds beyond the initial message exchange, improving testing coverage. To be able to assign the rules to correct message field elements, it is very beneficial to be able to show to the user good descriptive field names. This user interactive rule assigning and interesting field marking is called edit time usage. The use of PDML format simplifies significantly such edit time usage.

When executing a test case of a network protocol, it is beneficial to know, especially for performance purposes, when to stop reading data from the network. Generally, the structure of the data read from the network must be known in order to determine whether all data relevant to testing has been read from the network. If the structure of the data is unknown to the testing process that reads data from the network interface, the data read process must wait until network timeout before it can stop the read operation and proceed with the test case. The waiting of timeouts slows down the testing process significantly. This kind of optimization of processing is called execution time usage.

As mentioned earlier, a PCAP capture can be processed in a dissector to produce user understandable format that has field names in place. TShark is a well known software application that can dissect PCAP files into PDML output. One problem is caused by the TShark application dissection logic. To be able to assign field names, the application may identify the used protocol by the standard or well known port number. For example, if TCP port used in PCAP is 80, the application may assume that the protocol is HTTP. If a non standard port is used, the data may be incorrectly decoded as some other protocol or may be not decoded at all.

### OBJECTS OF THE INVENTION

An object of the present invention is to provide a method and arrangement that allows utilization of readily available software tools, e.g. a network protocol dissector, for testing a network protocol. Another object of the present invention may be to enhance the performance and controllability of test execution. Yet another object of the present invention may be to reduce the user access rights requirements of executing a test.

### SUMMARY OF THE INVENTION

An aspect of the invention is a method for preparing data received from data communication network, e.g. for testing purposes. The method is characterized in that it comprises steps of reading data from a communication network socket, adding at least one header data field to the read data to create a packet interpretable by a network protocol dissector, and forwarding the created data packet to the network protocol dissector for further conversion of read data to a data analysis format.

The socket may be e.g. an IP, TCP, UDP, or STCP socket. There may be other corresponding socket interfaces.

The data fields of the step of adding at least one header data field may comprise data fields needed to convert the read data into format of the protocol of a lower or the lowest layer of e.g. the OSI protocol model. One such conversion is e.g. adding Ethernet protocol, IP protocol and TCP protocol headers to dissect data received from a TCP socket. One may also need to add fake capture frames to data, which make the result look like it is captured from network interface, for the dissector to accept the data and process it as expected. An example of such capture format is libpcap.

In an embodiment, data may be transmitted in the data communication network in an encrypted form. The encrypted data may be decrypted by a lower layer protocol before it is read from the communication network socket.

In an embodiment, the added header data field may be a data field of an arbitrarily selected network protocol. The network protocol may be selected e.g. based on the performance and/or capabilities of the protocol dissector.

In an embodiment, the method may comprise the step(s) of comparing a plurality of protocols in terms of dissecting efficiency and/or capability and/or selecting, e.g. based on the comparison, a suitable protocol according to which the data field(s) are added.

The format of the data to be forwarded to the dissector may be e.g. PCAP format or its functional equivalent.

The data analysis format may be e.g. PDML format or its functional equivalent.

The method may further comprise the step of controlling the read process utilizing the data converted to data analysis format.

In an embodiment, the method may comprise the step of composing a response message to the read message utilizing the data converted to the data analysis format and at least one rule to assign a value to a data field of the response message.

Another aspect of the invention is a computer arrangement that comprises the means for executing the steps of the method disclosed herein.

Yet another aspect of the invention is a computer program product that comprises the computer executable instructions for performing the steps of the method disclosed herein.

Some embodiments of the invention are described herein, and further applications and adaptations of the invention will be apparent to those of ordinary skill in the art.

### BRIEF DESCRIPTION OF DRAWINGS

In the following, the invention is described in greater detail with reference to the accompanying drawings in which

FIG. 1 shows an exemplary arrangement according to an embodiment of the present invention,

FIG. 2 shows an exemplary method according to an embodiment of the present invention,

FIG. 3 shows another exemplary method according to an embodiment of the present invention, and

FIG. 4 shows yet another exemplary method according to an embodiment of the present invention.

### DETAILED DESCRIPTION OF THE DRAWINGS

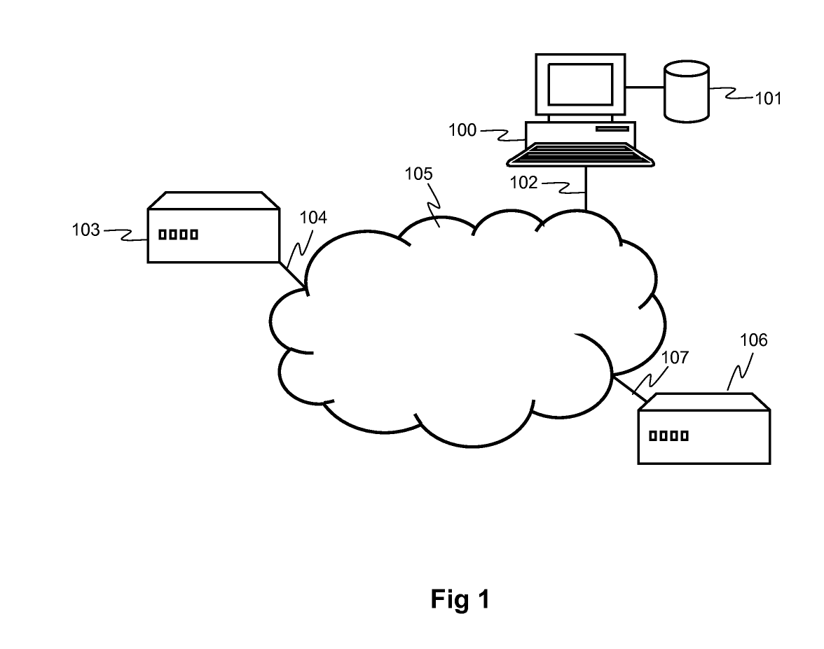

FIG. 1 shows an exemplary arrangement according to an embodiment of the present invention. The arrangement may comprise at least one device under test 103 that is communicatively connected 104 to a data communication network 105 (e.g. a TCP/IP network). The arrangement further comprises a tester computer 100 that comprises a storage 101 device and that is also communicatively coupled 102 to the data communication network. In an embodiment, the network may comprise further devices under test 106 that are also communicatively connected 107 to the data communication network 105.

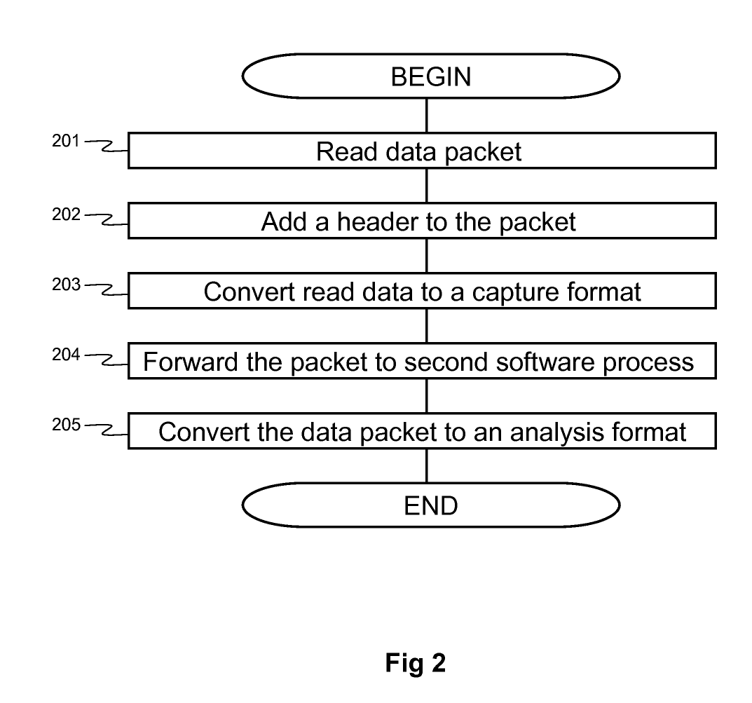

FIG. 2 depicts a method of an embodiment of the present invention. Data may be read 201 from application socket (e.g. TCP socket or UDP socket). Then, at least one header (“fake”) field is added 202 to the received data to make it look like a packet of a protocol of a lower layer of the OSI model, e.g. adding TCP header, IP header and Ethernet header as well as Libpcap headers to make it appear to be libpcap traffic capture 203. It may be required to split received data into multiple segments to conform to the lower layer protocol, e.g. IP datagram maximum size. The appended data packet is then forwarded 204 to a second software process, e.g. to a dissector program such as TShark, that converts 205 the received and appended data packet from e.g. the libpcap format into a format suitable for analysing the content of the package. One such format is e.g. the PDML format (Packet Details Markup Language). The dissector program requires that the data provided appears to be in the format of a captured network traffic. The addition of the fake headers is thus needed in order to enable the standard dissector software to transform the data packet into the data analysis format that advantageously contains meta-data about the fields of the data packet. Once the data packet is in the analysis format, various testing operations, e.g. checking the values of the fields of the packet or assembling a response message, possibly utilizing the data of the read message, may be performed.

Because the data is read from the network from a relatively high layer, e.g. from TCP or UDP socket , administrator level access to the Device Under Test (DUT), from which the data packet is read, is typically not needed. This simplifies in many occasions the administrative burden of the testing process. Testing a protocol of the higher layer of the OSI model may be performed without having extensive admin rights to the device under test. Furthermore, by making PCAP messages with fake headers from the actual received data, there is no need for low level capture software, and still the data can be made into a format that is identified by the dissector application. Low level capture SW often requires administrative rights on the PC host where they are needed. In the invention these high level access rights are not needed.

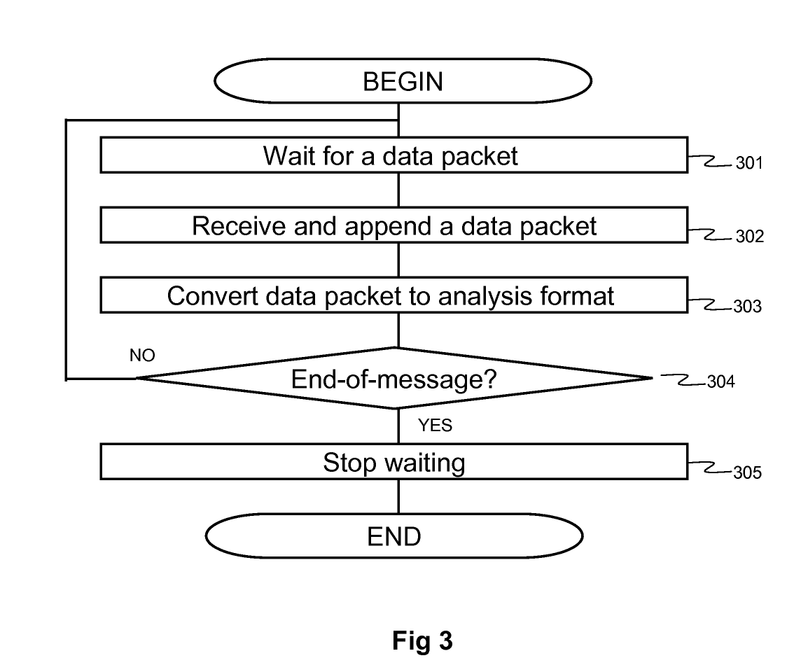

FIG. 3 illustrates an exemplary method of controlling the network read operations of a testing process. The testing process waits to read data from a socket or similar network interface 301. Once it receives data, it appends the data with at least one header field 302 and converts data into e.g. standard capture format, e.g. PCAP format. Next, data that has the added “fake header(s)”, is converted to the analysis format (e.g. PDML) 303. The testing program may now read the PDML-formatted data packet and check from the content of the packet if the read operation is completed 304. If further data need to be read, the method waits for more data to arrive 301. If all data required by the testing process have been read, the read operation is terminated 305. This embodiment has the advantage that data read operations may be terminated promptly once all relevant data has been read and there is no need to wait for any timeout to occur. The performance of the testing process may thus be greatly enhanced.

In an embodiment, the data read from the socket can be appended with the fake lower level PCAP format headers and immediately be given to e.g. TShark program for decoding. The decoding may happen while data is still being read from the socket. If the PDML-output from TShark contains the needed fields, for example a counter value that is needed in the next outgoing message, the reading and processing can be stopped mid message, read data may be emptied and processing the real message testing can be made faster. And PDML output may explicitly state when the message has been read fully, at which state the reading can be stopped and there is no need to wait for the timeout value. Timeout can be many seconds, and in test scenarios with hundreds of thousands of test cases it is not practical to wait for timeouts.

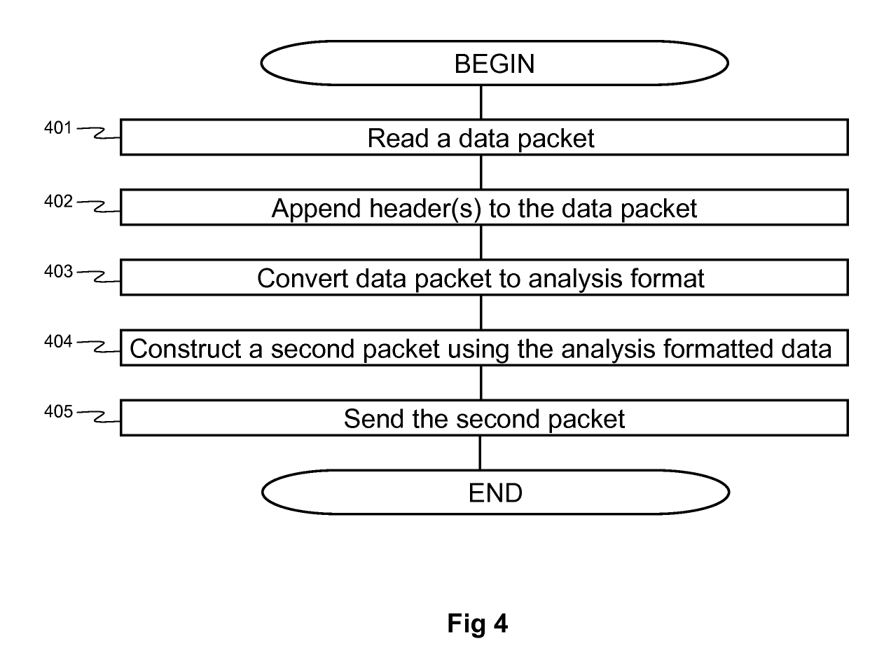

FIG. 4 illustrates an exemplary method of executing a test comprising reading a packet from the network interface and constructing a response message. The testing process running e.g. in the tester computer 100 reads a data packet originating e.g. from the device under test 103 from the network 401, appends the headers necessary to make the packet look like a packet of a lower-level protocol 402. Then the testing process converts the data packet to the analysis format (e.g. PDML-format) 403 e.g. utilizing a suitable dissector program, e.g. TShark. After the conversion, the testing process may perform any testing operations on the PDML-formatted data, including constructing a response message 404. The response message may contain some data from the packet read in step 401. Finally, the response message is sent to the network 405.

In an embodiment, the user can select the low-level protocol in use, which is mapped to standard or well known ports that are used in the fake headers. This helps dissector with the correct decoding of the received data.

Sometimes the outgoing messages may also be created by dissecting some sample traffic, either captured or for which fake headers have been created as described earlier. Such output messages have the dissected protocol structure in place, and the structure may be used to help intelligently modify the outgoing message for testing purposes. However, since dissectors do not provide rules how the field values depend from each other and from received messages, structure modifications may make the message invalid for the protocol. These rules may be provided to augment this approach. The rules may say e.g. how fields in the structure relate to each other and also how fields from incoming messages are copied or otherwise used to determine the correct field values in later outgoing messages. For example, a “session id” field from incoming message must have identical value in outgoing message “session id” field.

Also, user can mark the fields needed so that in execution time, socket reading can be further optimized by reading the message only to the point where the user marked field is received and can be utilized in next outgoing message creation.

An advantage of an embodiment of the invention is that the incoming data field of interest (for rule processing) is not always at same offset from the beginning of the message. Likewise, the value may be at different offset in the outgoing message preceded by some variable length dynamic data. There may be variable length data before the interesting data. PDML meta-data is not offset sensitive, instead it clearly labels the protocol fields based on the internal dissection information (simple model) giving a reliable place where the interesting field value begins. Thus the reliability of rule source and target data is greatly enhanced.

An embodiment of the invention provides transparency across different low-level encryption methods or unsupported transport protocols. E.g. analyzed application data may be protected by Transport Layer Security (TLS) encryption so that it is impossible for a network capture system to decrypt the data. However, with this invention the data is read after the TLS sub-system has decrypted the data.

There is no need to add any encryption for the appended fake fields and thus even the originally TLS encrypted data is in non-encrypted form and suitable for the dissection. The same applies if the data is originally received over a transport layer which would not be supported by the dissector or whose dissecting requires more processing power or memory resources than dissecting of some other protocol. As the fake headers which the dissector can dissect successfully and/or efficiently are appended, advantage of the analysis output can be taken, even when the original read data would not be dissected at all or would be dissected in a non-optimal manner.

An embodiment of the invention provides a way for more compact way of storing large amount of application data compared to saving full network captures. Full network captures make it possible to afterward dissect selected data. With this invention one can only store application data and later, when required, add the fake headers to allow dissection of data. Since storage does not need to contain the headers, the data is in more compact form.

To a person skilled in the art, the foregoing exemplary embodiments illustrate the model presented in this application whereby it is possible to design different methods, arrangements and software programs, which in obvious ways to the expert, utilize the inventive idea presented in this application.

We claim:

1. A method for preparing data received from a data communication network, the method comprising steps:
(a) reading data from a communication network from a socket network interface,
(b) adding at least one lower level header data field to the read data to create a packet of a lower protocol layer interpretable by a network protocol dissector, and
(c) forwarding the created data packet to the network protocol dissector for further conversion of read data to a data analysis format.

2. A method according to claim 1, wherein the network interface is a socket interface.

3. A method according to claim 2, wherein the socket interface is any of the following: IP, UDP, TCP or STCP.

4. A method according to claim 1, wherein the data fields of the step of adding at least one header data field comprise data fields needed to convert the read data packet into format of the protocol of the lowest layer of OSI protocol model.

5. A method according to claim 1, wherein the data capture format is PCAP format or equivalent.

6. A method according to claim 1, wherein the data analysis format is PDML format or equivalent.

7. A method according to claim 1, wherein the method further comprises step of selecting the added at least one header data field based on dissecting performance and/or capability of the network protocol dissector.

8. A method according to claim 1, said wherein the method further comprises the step of controlling the read process of step (a) utilizing the data converted to data analysis format.

9. A method according to claim 1, wherein the method further comprises the step of composing a response message to the read message utilizing the data converted to the data analysis format and at least one rule to assign a value to a data field of the response message.

10. An arrangement for preparing data received from a data communication network, comprising:
a. means for reading data from a communication network from a socket network interface,
b. means for adding at least one lower layer header data field to the read data to create a packet of a lower protocol layer interpretable by a network protocol dissector, and
c. means for forwarding the created data packet to the network protocol dissector for further conversion of read data to a data analysis format.

11. A software program for preparing data received from a data communication network, the software program comprising computer executable instructions for:
a. reading data from a communication network from a socket network interface,
b. adding at least one lower layer header data field to the read data to create a packet of a lower protocol layer interpretable by a network protocol dissector, and
c. forwarding the created data packet to the network protocol dissector for further conversion of read data to a data analysis format.
